(19) United States
(12) Patent Application Publication
(10) Pub. No.: US 2013/0301138 A1
(43) Pub. Date: Nov. 14, 2013

(54) MARKING BOARD WITH BACK-FOCUSING AND BRIGHTNESS ENHANCEMENT EFFECT

(71) Applicants: Shuei-Tian CAI, Taichung City (TW); Lieh-Hsiung HU, Taichung City (TW)

(72) Inventors: Shuei-Tian CAI, Taichung City (TW); Lieh-Hsiung HU, Taichung City (TW)

(73) Assignee: SAFETY TRAFFIC EQUIPMENT CO., LTD., Taichung City (TW)

(21) Appl. No.: 13/467,631

(22) Filed: May 9, 2012

(51) Int. Cl. G02B 27/12

(52) U.S. Cl. 359/619

(57) ABSTRACT

A marking board with back-focusing and brightness enhancement effect has a board body having a plate-type pattern to define a marking surface and a rear surface. Of which the marking surface is provided with a marking portion. Multiple through-holes are arranged at interval within the range of the marking portion on the marking surface of the board. Multiple light-focusing lenses are installed on the rear surface of the board body correspondingly to the through-holes. The light focusing lenses include a transparent protruding end, a light-focusing member and at least a positioning member. The sunlight or preset light source could be back-focused via said light-focusing lens, and transmitted via the marking surface, so as to enhance the brightness, promote the identification effect of the marking portion and significantly reduce the cost with better applicability and industrial and economic benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a marking board, and more particularly to an innovative one which is designed with a back-focusing function for lens brightness enhancement effect.

2. Description of Related Art Including Information Disclosed Under 37 CFR 1.97 and 37 CFR 1.98

The marking board referred hereto means any kind of plate-type product for marking purposes, for example, commonly-used traffic sign board, advertising board and billboard.

The marking board is structurally designed to optimize the visibility of the marked contents as one of key design considerations. Currently, LED light-emission technology and structure have been introduced into the marking board. Notwithstanding LED can really resolve the poor visibility of the marking boards in harsh weather conditions and during nighttime, LED is still faced with the problems such as: power consumption and components damage. Besides, the circuit lauserst, automatic power-generating and storage structure are much complex than common marking boards, whilst the configuration and maintenance cost will also increase substantially. As for some marking boards of lower availability, the efficacy brought about from installation of LED is relatively low (as compared with the installation cost). Or, from another perspective, if LED mounted onto the conventional marking board is turned off since it is not operated around the clock, the brightness enhancement effect will be lost. However, when LED components as well as the circuit and power storage structure are operated around the clock, the possible damage will increase greatly. For these reasons, there is a need of developing an integrated structure so that the marking board could realize proper and actual brightness enhancement effects with minimized cost, so as to meet diversified user demands.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the innovative structural design of the present invention wherein the marking board with back-focusing and brightness enhancement effect comprises: a board body, multiple through-holes and multiple light-focusing lenses, the sunlight or preset light source could be back-focused via the light-focusing member of the light-focusing lens, and transmitted via the transparent protruding end, so as to enhance the brightness, promote the identification effect of the marking portion and significantly reduce the cost with better applicability and industrial and economic benefits.

Moreover, based on the technical characteristics that said light-focusing lenses are located into the through-holes of the marking board to realize brightness enhancement, the components of the present invention could be easily configured, without problems such as circuit lauserst and LED components damage or replacement. Thus, the brightness enhancement structure of the marking board of the present invention could be installed more conveniently; as for the preferred embodiment of the present invention, since the light-emitting device and light-focusing lens are separately assembled, the light-emitting device could be designed into an integrated modular pattern. When the light-emitting device is repaired and replaced, the marking board and the light-focusing lens are not involved, bringing about more convenient maintenance and replacement than conventional structure.

The improvements brought about by this invention are as follow:

Based on the technical characteristics wherein reflecting film is set locally onto the periphery of the light-focusing member of the light-focusing lens, the light reflected from the rear surface of the board body is blocked by the reflecting film and reflected again onto the light-focusing member, helping to make full use of external light to realize the brightness enhancement effect.

Based on the technical characteristics wherein the light-focusing member of the light-focusing lens and the transparent protruding end are designed into a combined pattern, the light-focusing member and the transparent protruding end could be fabricated into different colors to emit rays of various colors. For example, when said marking portion 13 is used for warning (e.g. Caution! Children, Beware of Falling Rocks, etc.), the transparent protruding end or the light-focusing member can be made of red transparent materials, so that the marking portion emits red light as a warning signal to the pedestrian. Or, a color cover made of transparent materials is sleeved on the transparent protruding end of the light-focusing lens, and its color differs from that of the light-focusing lens so as to emit colorful lights for the pedestrian.

Although the invention has been explained in relation to its preferred embodiment, it is to be understood that many other possible modifications and variations can be made without departing from the spirit and scope of the invention as hereinafter claimed.

BRIEF DESCRIPTION OF THE SEVERAL VIEWS OF THE DRAWINGS

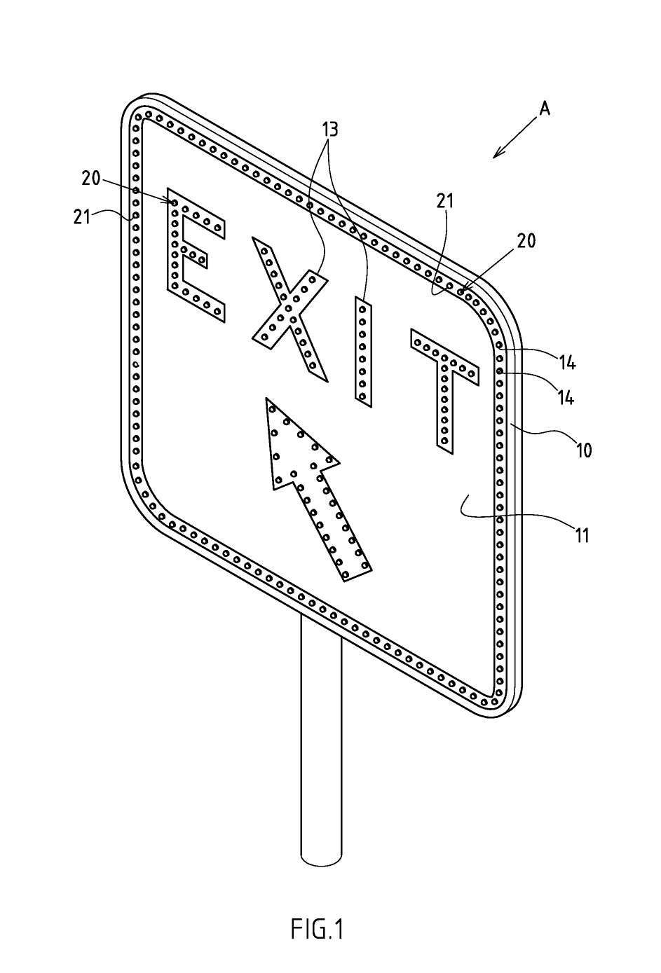

FIG. 1 is an assembled perspective view of the marking board of the present invention.

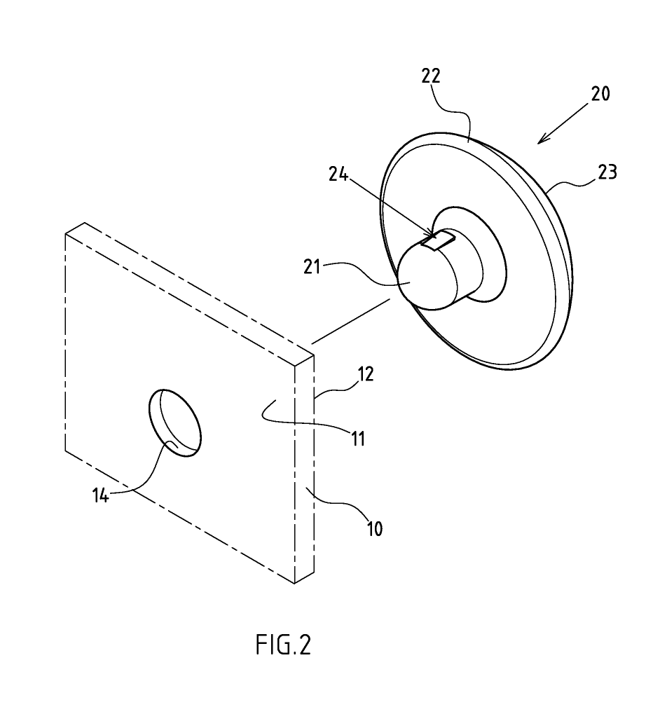

FIG. 2 is an exploded perspective view of the light-focusing lens and the board body of the present invention.

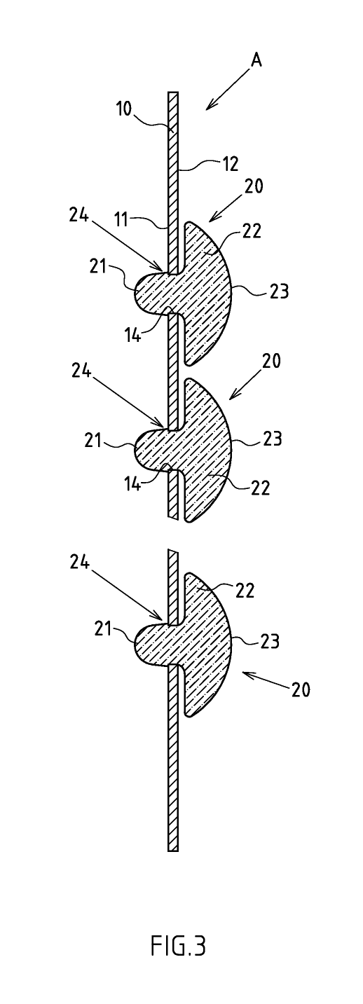

FIG. 3 is an assembled sectional view of the marking board of the present invention.

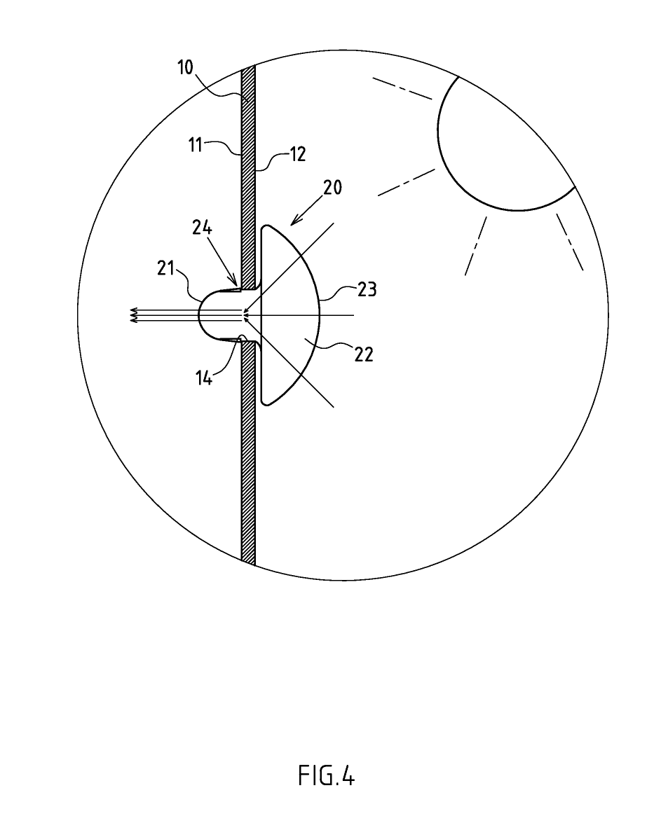

FIG. 4 is a plan view of the present invention wherein backward lights are focused by the marking board via said light-focusing lens and transmitted via the marking surface.

FIG. 5 is an application view of the present invention wherein reflecting film is set locally onto the periphery of the light-focusing member of the light-focusing lens.

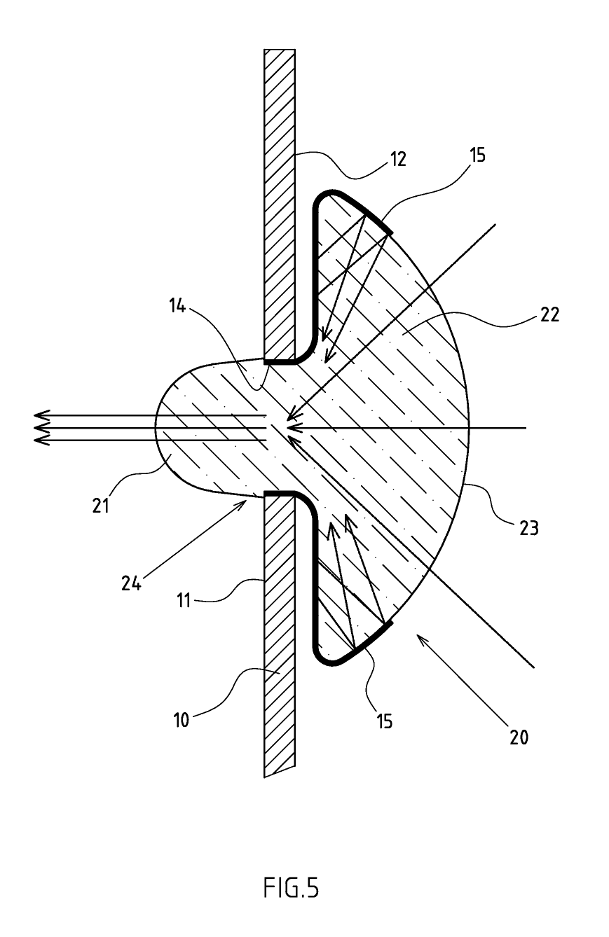

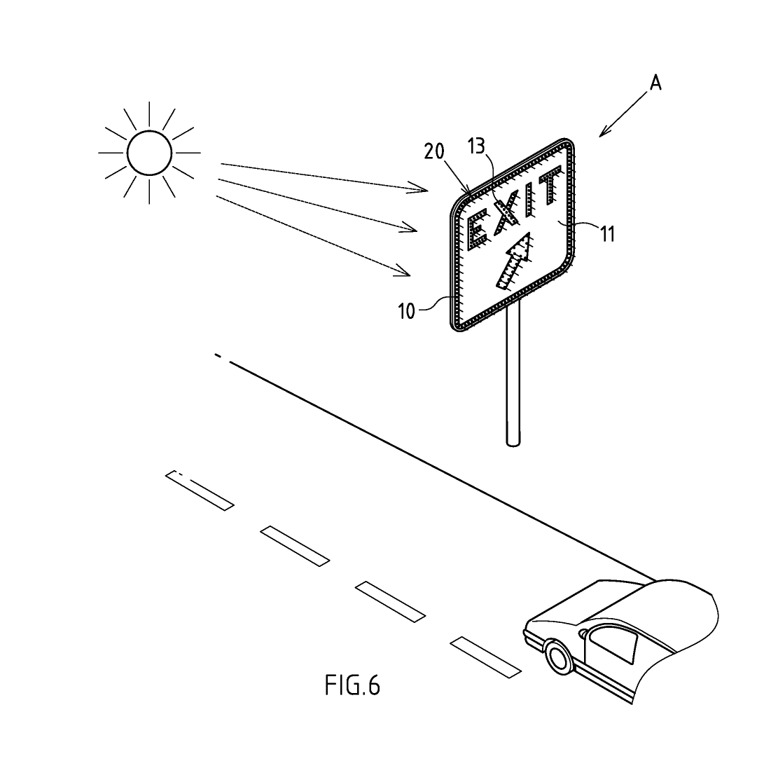

FIG. 6 is an application view of the present invention wherein backward lights are focused by the marking board via said light-focusing lens and transmitted via the marking surface.

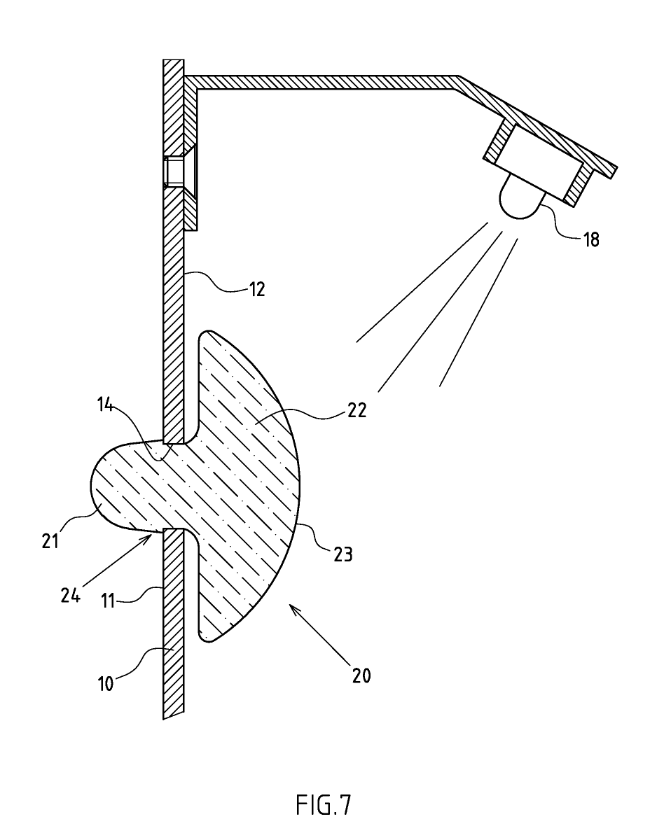

FIG. 7 is an application view of the present invention wherein the rear surface of the board body is provided with a light-emitting device.

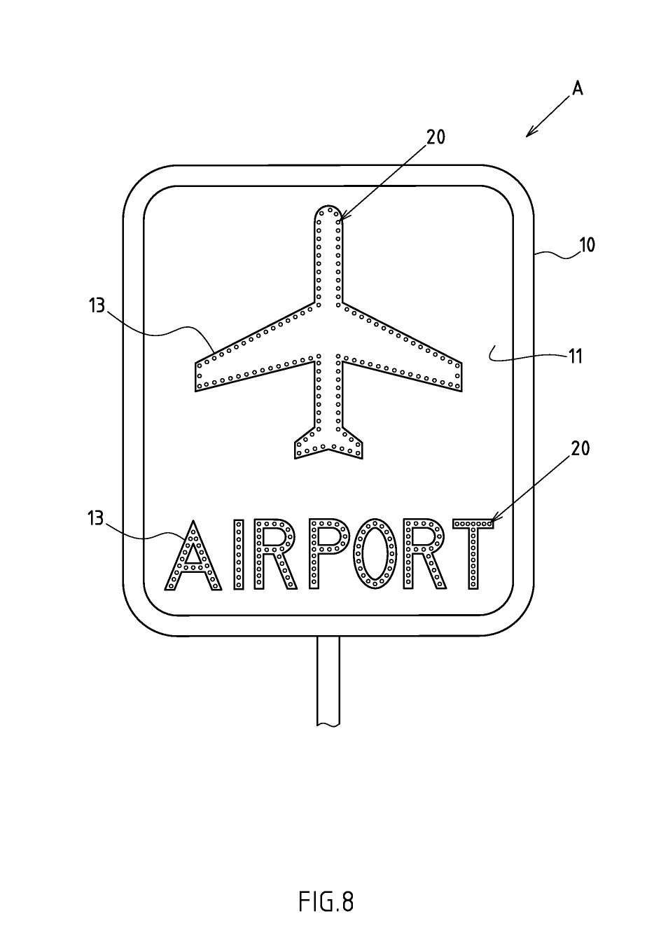

FIG. 8 is another application view of the marking board of the present invention.

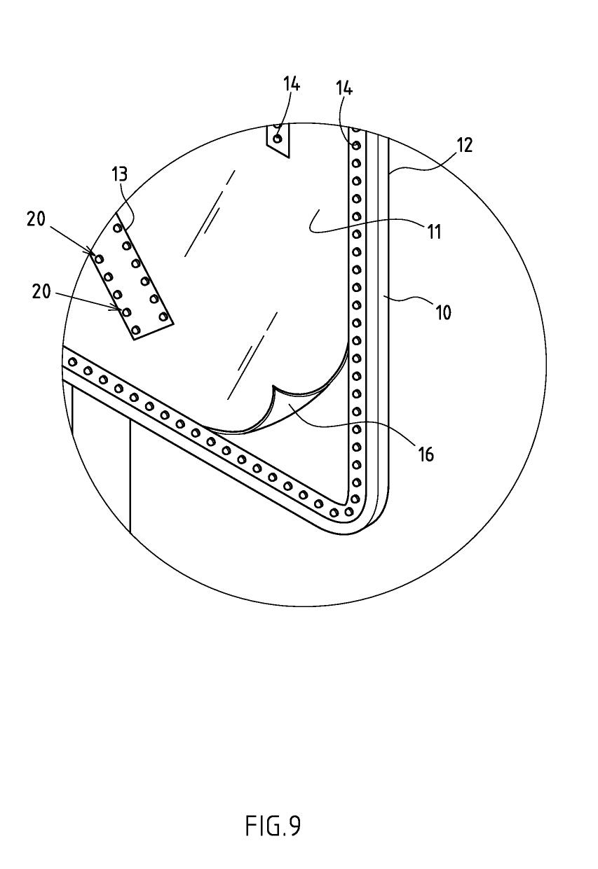

FIG. 9 is an application view of the present invention wherein the marking surface of the board body is attached with a reflecting layer.

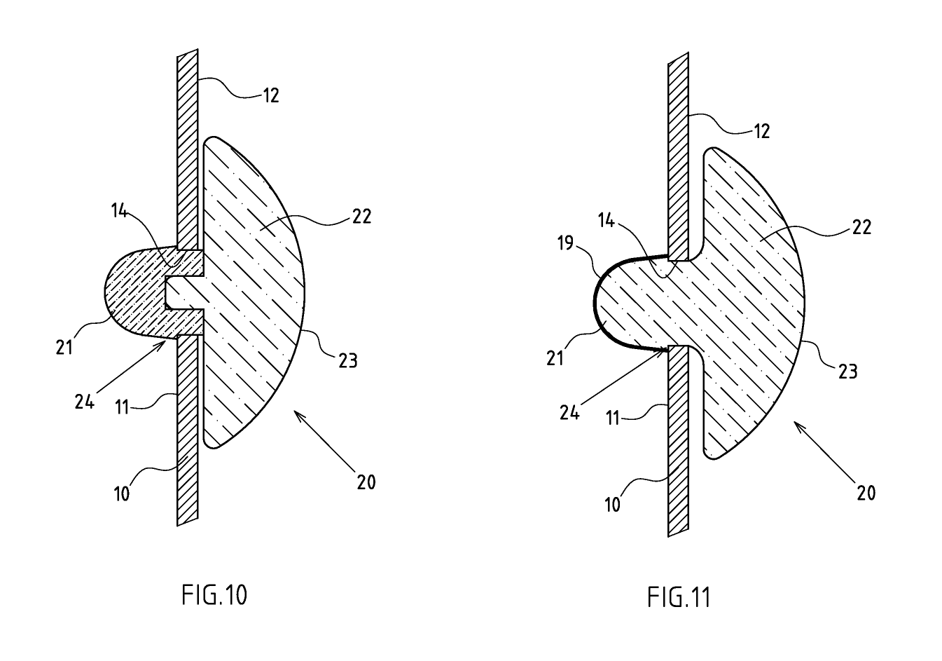

FIG. 10 is an application view of the present invention wherein the light-focusing member and the transparent protruding end are designed into a combined pattern.

FIG. 11 is an application view of the present invention wherein a color cover is sleeved onto the transparent protruding end of the light-focusing lens.

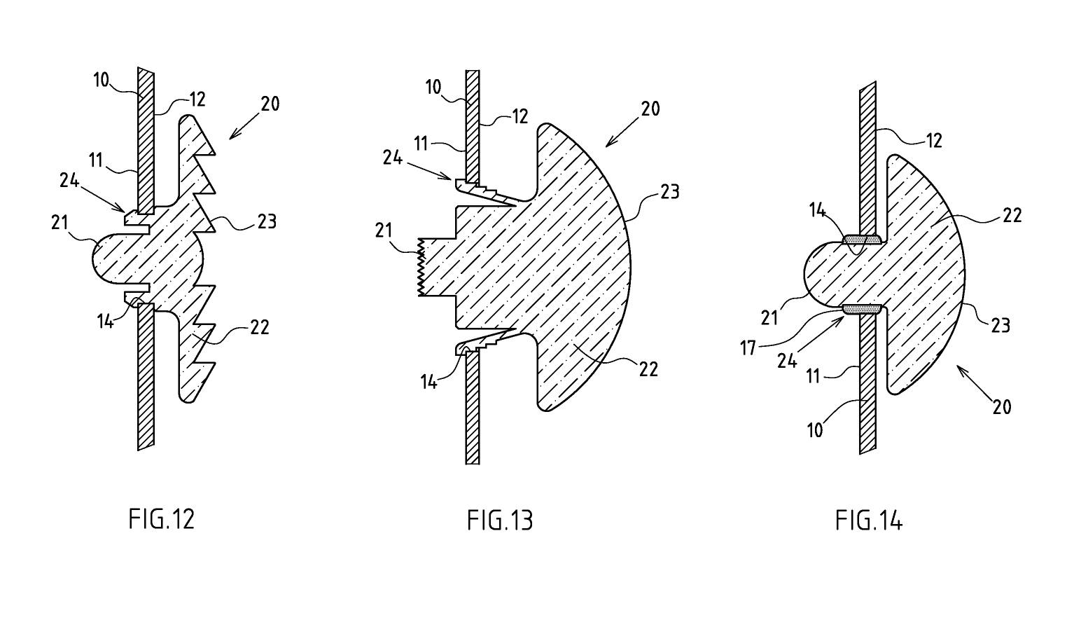

FIG. 12 is an application view of the present invention wherein the positioning member of the light-focusing lens is designed into an elastic hook and the light-focusing member is designed into Fresnel lens.

FIG. 13 is an application view of the present invention wherein the positioning member of the light-focusing lens is designed into stepped tip edge and the transparent protruding end is designed into toothed pattern.

FIG. 14 is an application view of the present invention wherein a soft sleeve is added onto the light-focusing member of the light-focusing lens.

### DETAILED DESCRIPTION OF THE INVENTION

FIGS. 1-5 depict the preferred embodiments of the marking board of the present invention with back-focusing and brightness enhancement effect, which, however, are provided for only explanatory objective for patent claims.

Said marking board A comprises a board body 10, designed into a plate-type pattern to define a marking surface 11 and a rear surface 12. Of which, the marking surface 11 is provided with a marking portion 13 of predefined shape. The board body 10 can also be designed into a flat or curved board.

Multiple through-holes 14 are arranged at interval within the range of the marking portion 13 on the marking surface 11 of the board body 10. Said through-hole 14 penetrates the marking surface 11 and rear surface 12 of the board body 10.

Multiple light-focusing lenses 20 are installed on the rear surface 12 of the board body 10 correspondingly to the through-hole 14. Each light-focusing lens 20 is made of transparent materials and comprises of: a transparent protruding end 21, a light-focusing member 22 and at least a positioning member 24. Of which, the transparent protruding end 21 is designed into a protruding pattern to be mated with the through-hole 14, so that it can be exposed onto the marking surface 11 of the board body 10. The light-focusing member 22 is connected with the rear-end of the transparent protruding end 21 and designed into an expanded pattern. The light-focusing member 22 is provided with a focusing surface 23 to focus and guide external light to the transparent protruding end 21 in brightness enhancement and light-transmission state. Said positioning member 24 is set onto at least either of the transparent protruding end 21 and the light-focusing member 22, allowing to position the light-focusing lens 20 on the rear surface 12 of the board body 10. Referring to FIG. 7, the positioning member 24 is located on the transparent protruding end 21. Referring to FIG. 12, said positioning member 24 is located on the light-focusing member 22. Of which, said board body 10 enables light to be focused and released via the transparent protruding end 21, so that the marking portion 13 can be more easily identified.

Of which, the positioning member 24 of the light-focusing lens 20 located on the rear surface 12 of the board body 10 comprises of either of an embedded flange, elastic hook (shown in FIG. 12), stepped tip edge (shown in FIG. 13), a frictional locator and soft sleeve 17 (referring to FIG. 14, the positioning member 24 allows the soft sleeve 17 to be added onto the periphery of the transparent protruding end 21 and then inserted tightly into the through-hole 14); the light-focusing member 22 of the light-focusing lens 20 comprises of either of arced (shown in FIGS. 3, 7) and conical Fresnel lens(shown in FIG. 12); the transparent protruding end 21 of the light-focusing lens 20 comprises of either of arced (shown in FIGS. 3, 7), flat, conical and toothed surface(shown in FIG. 13).

FIGS. 3, 4 and 5 depict the preferred embodiments of the light-focusing member 22 of the present invention, wherein the light-focusing member 22 of the light-focusing lens 20 can be designed into an expanded pattern.

Referring to FIG. 5, reflecting film 15 is set locally onto the periphery of the light-focusing member 22 of the light-focusing lens 20, so that the light previously refracted from the rear surface 12 of the board body 10 is blocked by the reflecting film 15 and reflected again onto the light-focusing member 22, helping to make full use of external light to realize the brightness enhancement effect.

Referring to FIG. 7, the rear surface 12 of the board body 10 can be provided with a light-emitting device 18, which is regarded as another projection light source of the light-focusing member 22 of the light-focusing lens 20. For example, in the absence of external light's irradiation at night, the marking portion 13 is of poor visibility. In such case, the light-emitting device 18 is set in a manner to emit lights only at night, then the light is focused via the light-focusing member 22 and guided to the transparent protruding end 21 in a light-transmission state. Hence, the brightness enhancement of the marking board A could be realized at night so as to improve the identification effect.

Referring to FIG. 9, the marking surface 11 of the board body 10 can be attached with a reflecting layer 16, which could enhance the brightness when the light (e.g.: vehicle light) is irradiated onto the marking surface 11, so as to enhance the identification function of the marking portion.

Referring to FIG. 10, the light-focusing member 22 of the light-focusing lens 20 and the transparent protruding end 21 can be fabricated independently and then assembled into a combined pattern, so that the light-focusing member 22 and the transparent protruding end 21 are fabricated separately into different colors to achieve special effects. For example, when said marking portion 13 is used for warning (e.g. Caution! Children, Beware of Falling Rocks, etc.), the transparent protruding end 21 or the light-focusing member 22 can be made of red transparent materials, so that the marking portion 13 emits red light as a warning signal to the pedestrian. Or, referring to FIG. 11, a color cover 19 made of transparent materials is sleeved on the transparent protruding end 21 of the light-focusing lens 20, with its color differ from that of the light-focusing lens 20 so as to emit colorful lights for the pedestrian.

Of which, said through-holes 14 are either arranged on the marking portion 13 of the marking surface 11 of the board body 10 or at the periphery area of the marking portions 13. Referring to FIG. 1, so that the light-focusing lenses 20 can be set correspondingly.

Based on above-specified structural design, the present invention is operated as follows:

Referring to FIG. 6, the marking board A is set on the marking surface 11 away from the sunlight; in such case, the pedestrian ca not see clearly the contents marked by the marking portion 13 because of backlighting, so the marking or warning effect of the marking portion 13 ca not be achieved. Referring to FIG. 4, based on the technical characteristics that multiple light-focusing lenses 20 are located on the rear surface 12 of the board body 10 correspondingly to the through-holes 14, the backward sunlight could be focused by the marking board A via the light-focusing member 22 of the light-focusing lens 20, and guided to the transparent protruding end 21 in a brightness enhancement and light-transmission state. So the brightness of the marking board A could be enhanced to improve its identification effect. And, in case where the marking board A is not in backlighting state during daytime, the brightness enhancement and light-transmission state could be achieved via the sunlight or other external lights. Thus, brightness enhancement of the present invention could be realized without addition of any light-emitting device during daytime, improving the Identification effect of the marking portion 13 and significantly reducing the configuration and maintenance costs. Referring also to FIG. 7, if the marking board A is used at night without any extraneous lights, the light source could be emitted by the light-emitting device 18 on the rear surface 12 of the board body 10, then focused and guided to the transparent protruding end 21, so that brightness enhancement of the marking board A could be realized at night.

1. A marking board with back-focusing and brightness enhancement effect, the marking board comprising:
a board body having a plate-type pattern to define a marking surface and a rear surface, of which the marking surface is provided with a marking portion of predefined shape;
multiple through-holes, arranged at interval within the range of the marking portion on the marking surface of the board body; and said through-hole penetrates the marking surface and the rear surface of the board body,
multiple light-focusing lenses installed on the rear surface of the board body correspondingly to the through-hole, the light-focusing lens is made of transparent materials, and comprises of:
a transparent protruding end, which is designed into has a protruded pattern to be mated with the through-hole, so that it can be exposed onto the marking surface of the board body;
a light-focusing member, which is connected with the rear-end of the transparent protruding end and provided with a focusing surface to focus and guide the external light to the transparent protruding end in brightness enhancement and light-transmission state;
at least a positioning member, which is set onto at least either of the transparent protruding end and the light-focusing member, allowing to position the light-focusing lens on the rear surface of the board body;
the sunlight or preset light source could be back-focused via the light-focusing member of the light-focusing lens, and transmitted via the marking surface, so as to realize brightness enhancement, and promote the identification effect of the marking portion.

2. The device defined in claim 1, wherein said positioning member of the light-focusing lens located on the rear surface of the board comprises of either of an embedded flange, elastic hook, stepped tip edge, frictional locater and attached soft sleeve; the light-focusing member of the light-focusing lenses comprises of either of arced and conical Fresnel lens; the transparent protruding end of the light-focusing lenses comprises of either of arced, flat, conical and toothed surface.

3. The device defined in claim 1, wherein the rear surface of the board body can be provided with a light-emitting device, which is regarded as another projection light source of the light-focusing member of the light-focusing lens.

4. The device defined in claim 1, wherein reflecting film is set locally onto the periphery of the light-focusing member of the light-focusing lens.

5. The device defined in claim 1, wherein the light-focusing member of the light-focusing lens and the transparent protruding end are fabricated independently and then assembled into a combined pattern.

6. The device defined in claim 1, wherein a color cover made of transparent materials is sleeved on the transparent protruding end of the light-focusing lens.

7. The device defined in claim 1, wherein the light-focusing member of the light-focusing lens can be designed into an expanded pattern.

8. The device defined in claim 1, wherein the marking surface of the board can be attached with a reflecting layer.

9. The device defined in claim 1, wherein said through-holes are arranged on the marking portion and at the periphery area of the marking surface of the board body.
